(19) United States
(12) Patent Application Publication
(10) Pub. No.: US 2019/0042664 A1
(43) Pub. Date: Feb. 7, 2019

(54) COMPUTER APPLIED MANAGEMENT TOOL

(71) Applicant: MOTIVACTR AB, Stockholm (SE)

(72) Inventor: Erik DAHLKVIST, Stockholm (SE)

(21) Appl. No.: 16/080,340

(22) PCT Filed: Mar. 1, 2017
(86) PCT No.: PCT/SE2017/000017

§ 371 Date: Aug. 28, 2018

(30) Foreign Application Priority Data
Mar. 1, 2016 (SE) 1600075-4

(51) Int. Cl. G06F 17/30; G09B 7/00

(52) U.S. Cl. CPC G06F 17/30991; G09B 7/00; G06F 17/30976; G06F 17/30867

(57) ABSTRACT

The computer applied management tool is for multiple users to create a digital presentation to a user of the tool of a chosen subject from the tool (10). The computer program generator provides a ranking scale graphics of confidence in the questions displayed on the screen. The user sets the felt confidence level of every question for said subject.

### TECHNICAL FIELD

The present invention pertains to a computer applied management tool for multiple users to create a digital presentation to a user of said tool of a chosen subject from the tool.

### BACKGROUND ART

Too many persons attending meetings and conferences are just being board, and attend to sit through it, without being any cleverer than when they arrived. About 50% of all meetings are perceived as pointless. This leads to enormous costs for companies and organizations in a non-productive time loss.

Likewise, this creates an equal big problem for schools and their education. The declining performance in schools observed mostly depends on poor teaching. The cause is known, and similar to school and business. Too much facts are provided to the listener in too short time, and tend to complicate matters. There is a shortage of creativity ways to convey messages. Speakers tend to care more about getting matters spoken, but too little about how it is received by listeners.

### SUMMARY OF THE INVENTION

The present invention aims to solve problems mentioned above, thus there are to variants of the present invention computer applied management tool. One tool for business, and one for education at schools.

Hence, the present invention sets forth computer applied management tool for multiple users to create a digital presentation to a user of the tool of a chosen subject from the tool. Hereby it comprises:

at least one computer with a digital screen connected to the tool through a tool management interface, and adapted to display information about the subject from the tool ;

a computer program random generator adapted to randomly retrieve questions from the tool about the subject in different categories of understanding skills, and displaying them on the screen to be answered and entered by a user;

a computer program generator providing a ranking scale graphics of confidence in the questions displayed on the screen, wherein the user sets the felt confidence level of every question for the subject;

a computer program render, which renders output data from the setting of confidence levels to the questions to determine in which category of questions a user needs further guidance;

an input program for the user, by which the user enters the general perception of confidence for the subject;

an electronic memory storage mapping a user profile regarding all inputs from the user, and the tool to be retrieved by the user for the digital presentation; and

a loop mode engaging the tool in accordance with an on/off commando means to start or stop the loop mode.

One embodiment according to the present invention comprises a library database storing all information about the subject presented by the tool in a map for other users with the same subject to be retrieved by them on their own will to start a planning of a presentation.

Another embodiment comprises that every question can be categorized as a follow up question to a previous main question, implementing that an answer to a main question answers a part of the main question, as an answer to a main question also answers a follow up question.

A further embodiment comprises a computer implemented search engine utilized to find user inspiration to a question selected by a user, where a user selects a question from the tool with one of a user ranked confidence level, entering text to the search engine of the type of free text or key words, with the output data, and through the selected question apply a search in several search engines, to receive inspiration, both within the tool, and for solutions outside the tool, and to present the result from the different search engines on said screen.

Moreover, the present invention sets forth a method for a computer applied management tool for multiple users to create a digital presentation to a user of the tool of a chosen subject from the tool,

Herewith, the invention comprises:

connecting at least one computer with a digital screen to the tool through a tool management interface, and adapted to display information about the subject from the tool;

generating through a computer program random generator to randomly retrieve questions from the tool about the subject in different categories of understanding skills, and displaying them on the screen to be answered and entered by a user;

providing through a computer program generator a ranking scale graphics of confidence in the questions displayed on the screen, wherein the user sets the felt confidence level of every question for the subject;

rendering through a computer program render, output data from the setting of confidence levels to the questions to determine in which category of questions a user needs further guidance;

entering through an input program for the user the general perception of confidence for the subject;

storing in an electronic memory storage a mapping of a user profile regarding all inputs from the user, and the tool to be retrieved by the user for the digital presentation; and

engaging through a loop mode the tool in accordance with an on/off commando means to start or stop the loop mode.

The attached method sub claims adhere to the attached device sub claims.

### BRIEF DESCRIPTION OF DRAWINGS

Henceforth, reference is had to the attached drawings for a better understanding of the present inventions embodiments and given examples, wherein:

FIG. 1 depicts one embodiment of the computer applied management tool in accordance with the present invention;

FIG. 2 schematically illustrates the computer applied management tool in a loop configuration in accordance with the present invention;

FIG. 3 illustrates how questions are derived from the computer applied management tool in accordance with the present invention; and

FIG. 4 schematically illustrates a flow chart for the method run on the computer applied management tool in accordance with the present invention.

### DETAILED DESCRIPTION OF PREFERRED EMBODIMENTS

As mentioned, the present invention aims to solve problems mentioned above, thus there are to variants of the present invention computer applied management tool. One tool for business, and one for education at schools.

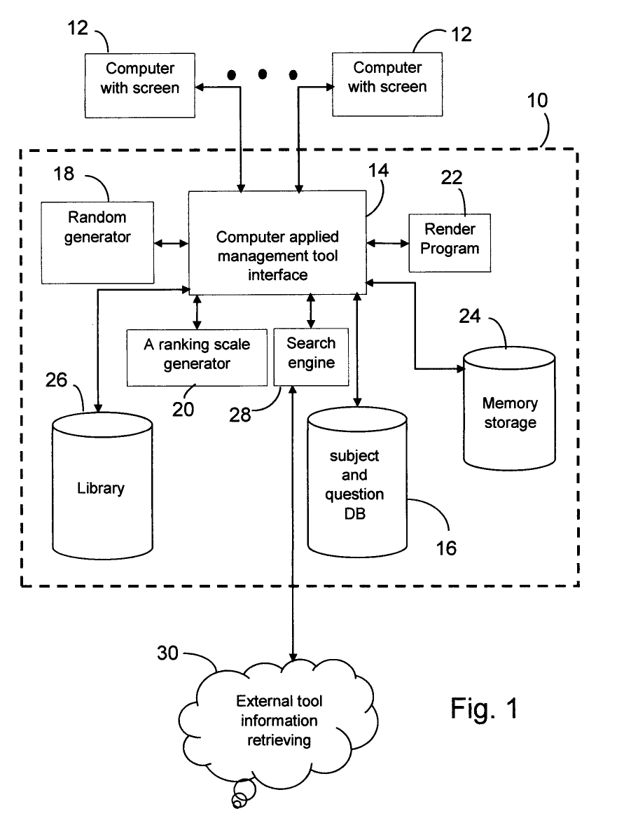

FIG. 1 depicts one embodiment of the computer applied management tool in accordance with the present invention. The computer applied management tool 10 has a plurality of computers 12, and multiple users (indicated by dots in FIG. 1) with digital screens connected to a computer applied management tool interface 14. All computers 12 belong to a user of the tool 10. A computer can be any kind of digital device able to connect to the interface 14 either through wire or wireless such as a PC, a smart phone, Ipad® or the like, adapted to display information about the subject from said tool management interface 14. The management interface 14 runs the tool 10 in accordance with input and/or output to the computers 12.

Furthermore, the tool comprises a subject and question database 16 prepared and being updated during use with questions about different subjects. Subjects can be of any kind of interest to a business or in education. A computer program random generator 18 is adapted to randomly, or by a predetermined scheme through for instance an algorithm for that purpose, to retrieve questions from the tool 10 and database 16 about the subject in different categories of understanding skills, and displaying them on the screen to be answered and entered by a user.

Moreover, a computer program random generator 18 is adapted, in one embodiment, to randomly retrieve questions from the database 16, and the tool 10 controlled by the interface 14, about the subject in different categories of understanding skills, and displaying them on said screen to be answered and entered by a user.

A further computer program generator 20 provides a ranking scale graphics of confidence in the questions displayed on the screen, wherein the user sets the felt confidence level of every question for the subject. Hereby, it is meant that a user should be provided inspiration, and feel confidence in the questions of the subject to reach a confidence level that is appropriate to hold a speech of the subject and/or to be educated in the field of the subject, which is further elaborated below.

The tool further comprises a computer program render 22, which renders output data from the setting of confidence levels to the questions answered by a user to determine in which category of questions a user needs further guidance or inspiration. In one embodiment, the render is accomplished by sorting questions with a low ranking of confidence for instance through an algorithm for this purpose.

There is provided an input program for the user, by which the user enters the general perception of confidence for the questions of the subject, i.e. an overall perception of confidence in the subject.

An electronic memory storage 24 stores a mapping of a user profile regarding all inputs from the user, and the tool to be retrieved by the user for e.g. a digital presentation or a school test for instance.

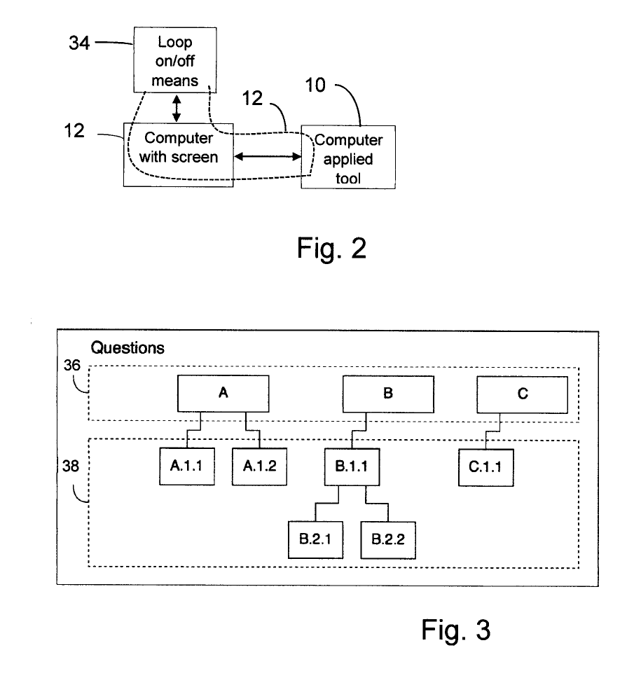

Whenever a user would like to start or end a session with the tool 10, a loop mode is provided engaging the tool 10 in accordance with an on/off commando means to start or stop the loop mode, preferably stop it when the users confidence level is sufficient. Such a loop mode operation could for instance be accomplished by pressing an icon, button on the computer screen. The loop mode is schematically depicted in FIG. 2.

Further, the tool 10 comprises a library database 26 storing all information about the subject presented by said tool 10 in a map for other users with the same subject to be retrieved by them on their own will to start a planning of a presentation. The tool 10 can also provide information stored in the library 26 to inspire the user or for education purposes.

The tool 10 comprises a computer implemented search engine 28 utilized to find user inspiration to a question selected by a user, where a user selects a question from the tool with one of a user ranked confidence level. Thus, entering text to the search engine of the type of free text or key words, with the output data, and through the selected question apply a search in several search engines. This to receive inspiration, both within the tool 10, and for solutions outside/external of the tool 30, and to present the result from the different search engines on the computer screen. Such an external solution could be retrieved for instance through Internet, databases and the like.

FIG. 2 schematically illustrates the computer applied management tool 10 in a loop configuration in accordance with the present invention, where the broken line depicts a loop, which can be deployed through a loop on/off means 34.

FIG. 3 schematically illustrates how questions are derived from the computer applied management tool in accordance with one embodiment of the present invention. There are depicted main questions 36 for a subject, and possible follow up questions 38 in FIG. 3.

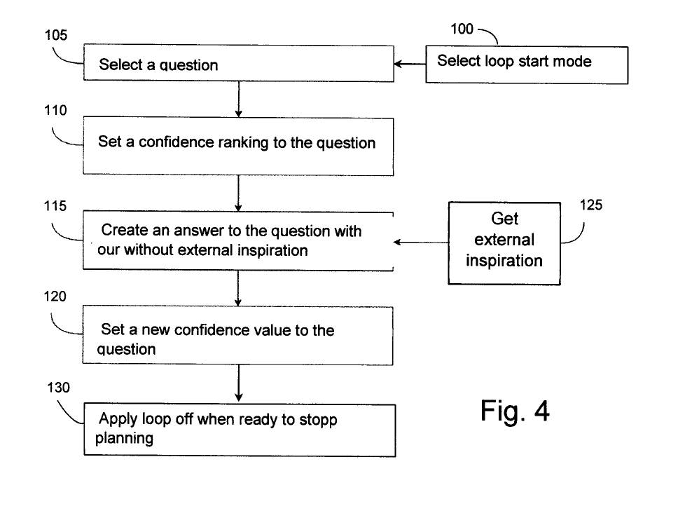

FIG. 4 schematically illustrates a flow chart for the method run on the computer applied management tool in accordance with the present invention. The text in boxes 100 to 130 is self-explanatory in accordance with was has been described above.

It is appreciated that the attached set of claims provides further possible embodiments for a person skilled in the art of the present technical field.

1. A computer applied management tool for multiple users to create a digital presentation to a user of said tool of a chosen subject from said tool, comprising:
at least one computer with a digital screen connected to said tool through a tool management interface, and adapted to display information about said subject from said tool;
a computer program random generator adapted to randomly retrieve questions from said tool about said subject in different categories of understanding skills, and displaying the questions on said screen to be answered and entered by a user;
a computer program generator providing a ranking scale graphics of confidence in said questions displayed on said screen, wherein said user sets the felt confidence level of every question for said subject;
a computer program render, which renders output data from said setting of confidence levels to said questions to determine in which category of questions a user needs further guidance;
an input program for said user, by which said user enters the general perception of confidence for said subject;
an electronic memory storage mapping a user profile regarding all inputs from said user, and said tool to be retrieved by said user for said digital presentation; and
a loop mode engaging said tool in accordance with an on/off commando means to start or stop said loop mode.

2. A tool according to claim 1, wherein the tool comprises a library database storing all information about said subject presented by said tool in a map for other users with the same subject to be retrieved by them on their own will to start a planning of a presentation.

3. A tool according to claim 1, wherein every question is categorized as a follow up question to a previous main question, implementing that an answer to a main question answers a part of said main question, as an answer to a main question also answers a follow up question.

4. A tool according to claim 1, wherein the tool comprises a computer implemented search engine utilized to find user inspiration to a question selected by a user, where a user selects a question from said tool with one of a user ranked confidence level, entering text to the search engine of the type of free text or key words, with said output data, and through the selected question apply a search in several search engines, to receive inspiration, both within the tool, and for solutions outside the tool, and to present the result from the different search engines on said screen.

5. A method for a computer applied management tool for multiple users to create a digital presentation to a user of said tool of a chosen subject from said tool, comprising:
connecting at least one computer with a digital screen to said tool through a tool management interface, and adapted to display information about said subject from said tool;
generating through a computer program random generator to randomly retrieve questions from said tool about said subject in different categories of understanding skills, and displaying them on said screen to be answered and entered by a user;
providing through a computer program generator a ranking scale graphics of confidence in said questions displayed on said screen, wherein said user sets the felt confidence level of every question for said subject;
rendering through a computer program render, output data from said setting of confidence levels to said questions to determine in which category of questions a user needs further guidance;
entering through an input program for said user the general perception of confidence for said subject;
storing in an electronic memory storage a mapping of a user profile regarding all inputs from said user, and said tool to be retrieved by said user for said digital presentation; and
engaging through a loop mode said tool in accordance with an on/off commando means to start or stop said loop mode.

6. A method according to claim 5, wherein the method comprises a library database storing all information about said subject presented by said tool in a map for other users with the same subject to be retrieved by the other users on their own will to start a planning of a presentation.

7. A method according to claim 5, wherein every question is categorized as a follow up question to a previous main question, implementing that an answer to a main question answers a part of said main question, as an answer to a main question also answers a follow up question.

8. A method according to claim 5, wherein the method comprises a computer implemented search engine utilized to find user inspiration to a question selected by a user, where a user selects a question from said tool with one of a user ranked confidence level, entering text to the search engine of the type of free text or key words, with said output data, and through the selected question apply a search in several search engines, to receive inspiration, both within the tool, and for solutions outside the tool, and to present the result from the different search engines on said screen.
